(19) United States
(12) Patent Application Publication
(10) Pub. No.: US 2022/0364490 A1
(43) Pub. Date: Nov. 17, 2022

(54) EXHAUST FLUID INJECTOR ASSEMBLY

(71) Applicant: Caterpillar Inc., Peoria, IL (US)

(72) Inventors: Samuel S. Kumar, Dunlap, IL (US); Matthew F. Fahrenkrug, Chillicothe, IL (US); Daniel R. Barb, East Peoria, IL (US); Ramakrishna Manda, Dunlap, IL (US); Paul A. Zwart, Dunlap, IL (US); Thierry A. Marchione, Heber City, UT (US); Kevin L. Martin, Washburn, IL (US)

(73) Assignee: Caterpillar Inc., Peoria, IL (US)

(21) Appl. No.: 17/317,865

(22) Filed: May 11, 2021

(51) Int. Cl. F01N 3/20; F01N 3/30

(52) U.S. Cl. CPC F01N 3/2066; F01N 3/30; F01N 2610/1453

(57) ABSTRACT

An injector for a diesel exhaust fluid (DEF) delivery system includes a first conduit extending along a longitudinal direction; a second conduit extending along the longitudinal direction and disposed within the first conduit; a nozzle tip having a side wall and an end wall; and a shell surrounding the first conduit and being spaced apart from the first conduit along a radial direction. The side wall has a thickness extending along the radial direction from an external surface of the nozzle tip to an inner surface of the second conduit. The end wall defines an outlet flow passage therethrough, and the outlet flow passage is in fluid communication with the first conduit and the second conduit via a chamber defined by an internal surface of the nozzle tip.

### TECHNICAL FIELD

The present disclosure is directed to an exhaust treatment system and, more particularly, to an injector assembly for injecting a reductant solution into an exhaust gas path within an exhaust treatment system.

### BACKGROUND

Internal combustion engines may generate an exhaust stream containing a mixture of combustion products, which may include nitrogen oxides (NOₓ), such as NO and NO₂. Some constituents in an exhaust stream, such as nitrogen oxides, may be subject to government regulation depending on the engine type and the type of machine embodying the engine. In turn, engine manufacturers endeavor to control regulated emissions through in-cylinder emissions control strategies, aftertreatment emissions control strategies, or combinations thereof.

Selective Catalytic Reduction (SCR) is a known aftertreatment emissions control strategy. In some SCR processes, a gaseous and/or liquid reductant, commonly urea ((NH₂)₂CO), is selectively added to the engine exhaust using one or more injectors. The injected reductant may thermally decompose into ammonia (NH₃), react with NO_{X} and other exhaust constituents on the surface of an SCR catalyst, and convert at least some of the exhaust NOx into unregulated emissions, such as water (H₂O) and diatomic nitrogen (N₂).

U.S. Pat. No. 9,168,545 (hereinafter “the '545 patent”) purports to describe a spray nozzle assembly that uses pressurized air to internally atomize a liquid before discharging the liquid from the nozzle assembly. The spray nozzle of the '545 patent includes a liquid supply passage and a plurality of air supply passages that are in fluid communication with discharge orifices via a chamber, where the chamber includes an impingement post with a diffuser.

While the '545 patent purports that the spray nozzles pre-mix pressurized air with a liquid inside the nozzles, the spray nozzles of the '545 patent may be suboptimal. For example, the structure of the internal flow passages may result in incomplete mixing of the air and liquid streams, and therefore may not result in a desired level of atomization, evaporation, and uniformity of the liquid constituent downstream of the spray nozzles. Where the injected liquid is an exhaust stream reductant, the non-atomized reductant may not fully evaporate to react with exhaust NOₓ on the surface of the SCR catalyst, and as a result may impair the NOₓ conversion efficiency of the overall SCR process. Further, the '545 patent describes a nozzle having multiple distinct and assembled parts, and such a multi-piece nozzle configuration may detrimentally increase the nozzle's size, complexity, assembly time, manufacturing cost, or combinations thereof.

Exemplary aspects of the present disclosure are directed to overcoming one or more deficiencies described above.

### SUMMARY

According to an aspect of the disclosure, an injector for a diesel exhaust fluid (DEF) delivery system includes a first conduit extending along a longitudinal direction; a second conduit extending along the longitudinal direction and disposed within the first conduit; a nozzle tip having a side wall and an end wall; and a shell surrounding the first conduit and being spaced apart from the first conduit along a radial direction, the radial direction being perpendicular to the longitudinal direction. The side wall has a thickness extending along the radial direction from an external surface of the nozzle tip to an inner surface of the second conduit, and the end wall defines an outlet flow passage therethrough. The outlet flow passage is in fluid communication with the first conduit and the second conduit via a chamber defined by an internal surface of the nozzle tip.

According to another aspect of the disclosure, an exhaust system for an internal combustion engine includes an exhaust conduit that receives exhaust gas from the internal combustion engine, and an injector for injecting diesel exhaust fluid (DEF) into the exhaust conduit. The injector includes a first conduit extending along a longitudinal direction; a second conduit extending along the longitudinal direction and disposed within the first conduit; a nozzle tip having a side wall and an end wall; and a shell surrounding the first conduit and being spaced apart from the first conduit along the radial direction, the radial direction being perpendicular to the longitudinal direction. The side wall has a thickness extending along the radial direction from an external surface of the nozzle tip to an inner surface of the second conduit, and the end wall defines an outlet flow passage therethrough. The outlet flow passage is in fluid communication with the first conduit and the second conduit via a chamber defined by an internal surface of the nozzle tip, and the chamber is in fluid communication with the exhaust conduit via the outlet flow passage.

### BRIEF DESCRIPTION OF DRAWINGS

FIG. 1 is a schematic diagram of an engine system, according to an aspect of the disclosure.

FIG. 2A is a rear perspective view of a nozzle portion, and FIG. 2B is a front perspective view of a nozzle portion, according to an aspect of the disclosure.

FIG. 3A is a rear perspective view of a nozzle portion, and FIG. 3B is a front perspective view of a nozzle portion, according to an aspect of the disclosure.

FIG. 4 is a top view of an injector assembly, according to as aspect of the disclosure.

FIG. 5 is a cross-sectional view of an injector assembly along section line 4-4, according to an aspect of the disclosure.

FIG. 6 is a cross-sectional view of an injector assembly along section line 4-4, according to an aspect of the disclosure.

FIG. 7 is a schematic view of a lattice structure, according to an aspect of the disclosure.

FIG. 8 is a cross-sectional view of a nozzle portion along section line 4-4, according to an aspect of the disclosure.

FIG. 9 is a perspective cross-sectional view of a nozzle tip and a nozzle extension, according to an aspect of the disclosure.

FIG. 10 is a front cross-sectional view of a nozzle tip and a nozzle extension, according to an aspect of the disclosure.

FIG. 11 is a front cross-sectional view illustrating flow patterns within a nozzle tip, according to an aspect of the disclosure.

FIG. 12 is an inverse flow surface view of a nozzle tip, according to an aspect of the disclosure.

### DETAILED DESCRIPTION

The present disclosure relates generally to nozzles for injecting a mixture of a liquid and a gas into an exhaust stream of a combustion engine. The same reference number(s) will be used throughout the drawings to refer to the same or like features, unless specified otherwise.

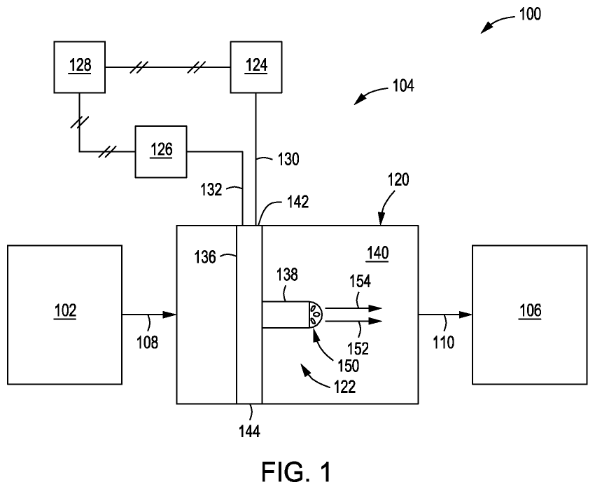

FIG. 1 is a schematic diagram of an engine system 100, according to an aspect of the disclosure. The engine system 100 includes an engine 102, an exhaust fluid injection system 104, and an emissions aftertreatment device 106. The exhaust fluid injection system 104 receives a flow of exhaust gas 108 from the engine 102, and the emissions aftertreatment device 106 receives a flow of modified exhaust gas 110 from the exhaust fluid injection system 104. A combination of the exhaust fluid injection system 104 and the emissions aftertreatment device 106 may be referred to herein as an exhaust system.

The engine 102 may be a spark-ignition piston engine, a compression-ignition piston engine, a rotary engine, a gas turbine engine, an electrochemical fuel cell, combinations thereof, or any other engine known in the art to produce an exhaust stream containing the products of a chemical reaction that occurs within the engine 102. The engine 102 may react a fuel with an oxidizer to produce the flow of exhaust gas 108. The engine 102 may be fueled by gasoline, diesel fuel, biodiesel fuel, dimethyl ether, alcohol, seed oils, gaseous or liquid hydrocarbon fuels such as methane or propane, natural gas, hydrogen, combinations thereof, or any other engine fuel known in the art. Oxidizer for the engine 102 may include air, exhaust gas, oxygen, custom blends including oxygen, combinations thereof, or any other oxidizer composition known in the art.

According to an aspect of the disclosure, the engine 102 is a compression-ignition piston engine using an air oxidizer. According to another aspect of the disclosure, the engine 102 is not a spark-ignition engine. According to yet another aspect of the disclosure, the engine 102 is not a gas turbine engine.

The exhaust fluid injection system 104 may include an exhaust duct 120 and an injector assembly 122 disposed at least partly within the exhaust duct 120. Accordingly, the exhaust duct may receive the flow of exhaust gas 108 from the engine 102, and the injector assembly 122 may be at least partly immersed in the flow of exhaust gas 108 within the exhaust duct 120.

The exhaust fluid injection system 104 may also include a supply of exhaust fluid 124, a supply of pressurized gas 126, and a controller 128 that is operatively coupled to the supply of exhaust fluid 124 and the supply of pressurized gas 126. The supply of exhaust fluid 124 is fluidly coupled to the injector assembly 122 via an exhaust fluid conduit 130, and the supply of pressurized gas 126 is fluidly coupled to the injector assembly 122 via a gas conduit 132. The controller 128 may be configured to selectively deliver exhaust fluid, pressurized gas, or both to the injector assembly 122, and may be configured to selectively withhold exhaust fluid, pressurized gas, or both from the injector assembly through operation of valves, pumps, compressors, or any other fluid control devices known in the art.

The exhaust fluid may include ammonia, urea, liquid hydrocarbons, water, combinations thereof, or any other liquid known in the art for injection into an exhaust stream. The pressurized gas may include air, nitrogen, steam, combinations thereof, or any other pressurized gas known in the art for injection into an exhaust stream. According to an aspect of the disclosure, the supply of exhaust fluid 124 is a supply of diesel exhaust fluid (DEF) containing urea, and the supply of pressurized gas 126 is a supply of pressurized air. According to another aspect of the disclosure, the supply of exhaust fluid 124 does not include a gas-phase component, and is exclusively a supply of liquid-phase exhaust fluid.

The injector assembly 122 may include a transverse portion 136 and a nozzle portion 138. The transverse portion 136 at least partly spans an internal volume 140 of the exhaust duct 120, and may be structurally coupled to the exhaust duct 120 at a first end 142, structurally coupled to the exhaust duct 120 at a second end 144, or structurally coupled to the exhaust duct 120 at both the first end 142 and the second end 144. Accordingly, the injector assembly 122 may be attached to or supported by the exhaust duct 120 at the first end 142 of the transverse portion 136, the second end 144 of the transverse portion, or both.

The injector assembly 122 is in fluid communication with the supply of exhaust fluid 124 via the exhaust fluid conduit 130, the supply of pressurized gas 126 via the gas conduit 132, or both. As shown in FIG. 1, the injector assembly 122 is fluidly coupled to the exhaust fluid conduit 130 at the first end 142 of the transverse portion 136, and fluidly coupled to the gas conduit 132 at the first end 142 of the transverse portion 136. However, it will be appreciated that the exhaust fluid conduit 130 and the gas conduit 132 may be fluidly coupled to opposite ends of the transverse portion 136.

The nozzle portion 138 may define outlet apertures 150 that are in direct fluid communication with the internal volume 140 of the exhaust duct 120. Further, the outlet apertures 150 may be in fluid communication with the supply of exhaust fluid 124, the supply of pressurized gas 126, or both, via flow passages defined within the transverse portion 136 and the nozzle portion 138. Thus, the internal volume 140 of the exhaust duct 120 may be in fluid communication with the supply of exhaust fluid 124, the supply of pressurized gas 126, or both, via the injector assembly 122.

The controller 128 may be configured to cause a flow of exhaust fluid 152 from the supply of exhaust fluid 124 into the internal volume 140 of the exhaust duct 120 via the injector assembly 122, cause a flow of gas 154 from the supply of pressurized gas 126 into the internal volume 140 of the exhaust duct 120 via the injector assembly, or cause both a flow of exhaust fluid 152 and a flow of gas 154 into the internal volume 140 of the exhaust duct 120. Although, flow of exhaust fluid 152 and the flow of gas 154 are shown separately in the schematic of FIG. 1, it will be appreciated that the flow of exhaust fluid 152 and the flow of gas 154 may leave the outlet apertures 150 of the injector assembly 122 in a co-mingled mixture.

According to an aspect of the disclosure, the flow of exhaust fluid 152 and the flow of gas 154 leave the outlet apertures 150 in a mixture of atomized exhaust fluid liquid, pre-vaporized exhaust fluid, and the flow of gas 154. As a result, the modified exhaust gas 110 may include the flow of exhaust gas 108 and the flow of exhaust fluid 152, the flow of gas 154, or both the flow of exhaust fluid 152 and the flow of gas 154. The exhaust fluid injection system 104 may be configured to promote spatial and/or temporal uniformity of concentration of exhaust fluid in mixture with the exhaust gas in the modified exhaust gas 110, which is conveyed to the emissions aftertreatment device 106.

The emissions aftertreatment device 106 may include an SCR catalyst, an oxidation catalyst, a particulate filter, combinations thereof, or any other emissions aftertreatment device known in the art to remove constituents from an exhaust stream or chemically convert constituents within an exhaust stream. Further, operation of the emissions aftertreatment device 106 may promote chemical reactions between the flow of exhaust fluid 152 and the flow of exhaust gas 108 in the modified exhaust gas 110. According to an aspect of the disclosure, the emissions aftertreatment device 106 includes an SCR catalyst that is configured to react NOx in the exhaust gas 108 with the flow of exhaust fluid 152 on the surface of the SCR catalyst, to reduce the NOx into water vapor and nitrogen.

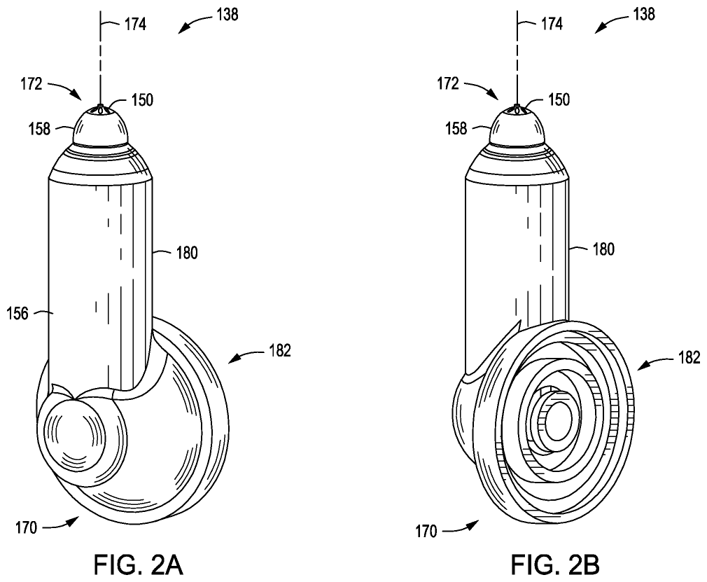

FIG. 2A is a rear perspective view of a nozzle portion 138, and FIG. 2B is a front perspective view of a nozzle portion 138, according to an aspect of the disclosure. The nozzle portion 138 may extend from a first end 170 to a second end 172 along a longitudinal axis 174. The nozzle portion 138 includes an external surface 180 that may be in direct contact with exhaust gas when the nozzle portion 138 is installed in an exhaust duct 120.

At the first end 170, the nozzle portion 138 may include a first connection portion 182 that provides features for making fluid connections with the transverse portion 136, supports the nozzle portion 138 in the exhaust duct 120, or both. The first connection portion 182 may be configured to receive socket weld connections, butt weld connections, threaded connections, compression connections, adhesive connections, combinations thereof, or any other fluid connection known in the art. According to an aspect of the disclosure, the first connection portion 182 includes a plurality of concentric socket weld connections. According to another aspect of the disclosure, the plurality of concentric socket weld connections is a plurality of circular cylindrical socket weld connections, with each socket weld connection being concentric with one another.

The second end 172 of the nozzle portion may define the outlet apertures 150 which extend through the external surface 180 to effect fluid communication between the external surface 180 and internal features of the nozzle portion 138. Further, the first connection portion 182 may be in fluid communication with the outlet apertures 150 via internal flow passages through the nozzle portion 138.

The nozzle portion 138 may include a nozzle extension 156 and a nozzle tip 158, where the nozzle extension 156 extends along the longitudinal axis 174 between the nozzle tip 158 and the first end 170 of the nozzle portion 138. An external surface of the nozzle extension 156 may be a cylinder that is centered on the longitudinal axis 174. According to an aspect of the disclosure, the external surface of the nozzle extension 156 is a circular cylinder that is centered on the longitudinal axis 174. It will be appreciated that the external surface of the nozzle extension 156 may have any shape that promotes beneficial interaction with a flow of exhaust gas 108.

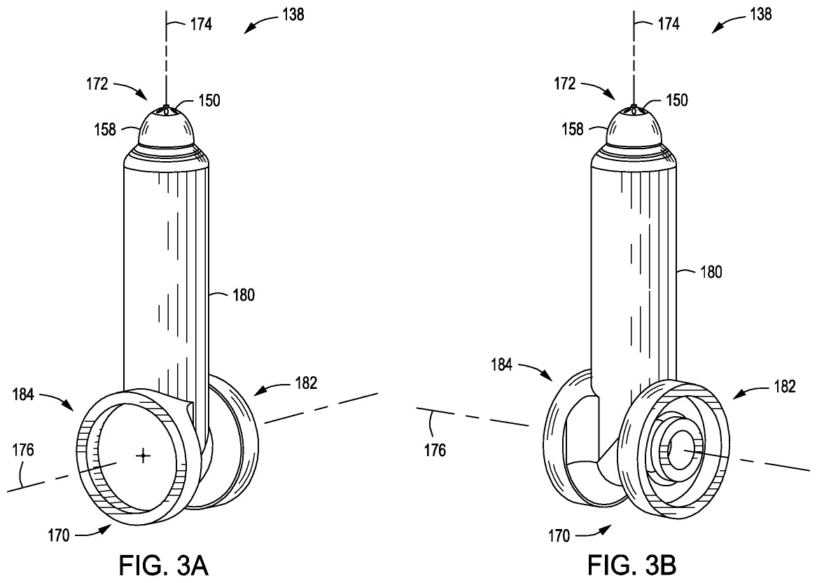

FIG. 3A is a rear perspective view of a nozzle portion 138, and FIG. 3B is a front perspective view of a nozzle portion 138, according to an aspect of the disclosure. The nozzle portion 138 may optionally include a second connection portion 184 located at the first end 170, which provides features for making fluid connections with the transverse portion 136, supports the nozzle portion 138 in the exhaust duct 120, or both. The second connection portion 184 may face away from the first connection portion 182 along a transverse axis 176. The second connection portion 184 may be configured to receive socket weld connections, butt weld connections, threaded connections, compression connections, adhesive connections, combinations thereof, or any other supporting connection known in the art.

According to an aspect of the disclosure, the second connection portion 184 includes a socket weld connection. According to another aspect of the disclosure, the second connection portion 184 is not in fluid communication with any part of the first connection portion 182, and is not in fluid communication with the inside of the nozzle portion 138 when the nozzle portion 138 is assembled with the transverse portion 136 to form the injector assembly 122. Instead, the second connection portion 184 may be blocked from fluid communication with the first connection portion 182 and the internal flow passages of the nozzle portion 138.

The transverse axis 176 is transverse to the longitudinal axis 174. According to an aspect of the disclosure, the transverse axis 176 is perpendicular to the longitudinal axis 174. According to another aspect of the disclosure, the transverse axis 176 is within 25 degrees of perpendicular with the longitudinal axis 174.

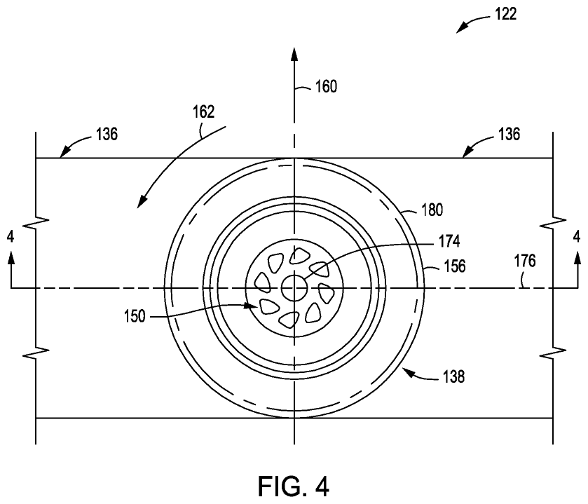

FIG. 4 is a top view of an injector assembly 122, according to as aspect of the disclosure. As shown in FIG. 4, a section line 4-4 may lie in a plane that includes both the transverse axis 176 and the longitudinal axis 174. The nozzle extension 156 illustrated in FIG. 4 may have an external surface that is a circular cylinder that is centered on the longitudinal axis 174.

The structure of the nozzle portion 138 may include surfaces of revolution that can be described in cylindrical coordinates including the longitudinal axis 174, a radial direction 160 extending normal to the longitudinal axis 174, and a circumferential direction 162 encircling the longitudinal axis 174. Being cylindrical coordinates, it will be appreciated that the radial direction 160 may extend away from the longitudinal axis 174 at any circumferential location about the circumferential direction 162.

Individual apertures of the outlet apertures 150 may be arranged in a uniformly-spaced circumferential array along the circumferential direction 162. Further, individual apertures of the outlet apertures may be located at a uniform radial distance from the longitudinal axis 174 along the radial direction 160.

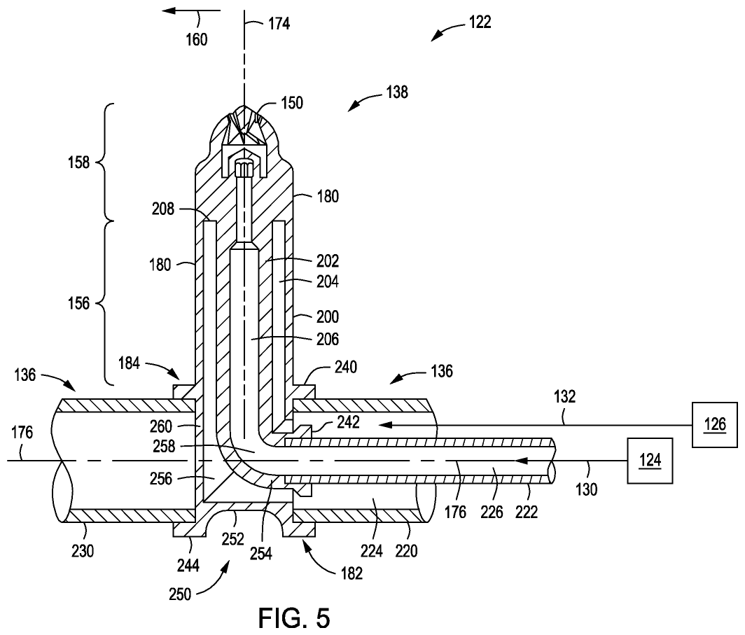

FIG. 5 is a cross-sectional view of an injector assembly 122 along section line 4-4, according to an aspect of the disclosure. The nozzle portion 138 may include a first axial conduit 200 extending along the longitudinal axis 174, and a second axial conduit 202 extending along the longitudinal axis 174 and disposed within the first axial conduit 200 along the radial direction 160. The first axial conduit 200 may be concentric with the second axial conduit 202.

An internal surface of the first axial conduit 200 and an external surface of the second axial conduit 202 define a first axial flow passage 204 through the nozzle portion 138. Thus, the first axial flow passage 204 may be an annular flow passage defined between the first axial conduit 200 and the second axial conduit 202. An internal surface of the second axial conduit 202 defines a second axial flow passage 206 through the nozzle portion 138. An end 208 of the first axial flow passage 204 may define an end of the nozzle extension 156 and the beginning of the nozzle tip 158 along the longitudinal axis 174. An external surface of the first axial conduit 200 may be in direct contact with exhaust gas when the injector assembly 122 is installed in the exhaust duct 120.

The internal surface of the first axial conduit 200 may directly face the external surface of the second axial conduit 202 along the radial direction 160. Unless specified otherwise, “directly face” may mean facing along a specified direction without any intervening structures disposed between the facing elements along the specified direction. Further, a first element may directly face a second element along a specified direction, even if only a portion of the first element faces the second element without any intervening structures disposed along the specified direction between the portion of the first element and the second element.

The transverse portion 136 includes a first transverse conduit 220 extending along the transverse axis 176, and a second transverse conduit 222 extending along the transverse axis 176 and disposed within the first transverse conduit 220. Further, the transverse portion 136 may optionally include a transverse member 230 extending along the transverse axis 176. An internal surface of the first transverse conduit 220 and an external surface of the second transverse conduit 222 define a first transverse flow passage 224 through the transverse portion 136. Thus, the first transverse flow passage 224 may be an annular flow passage defined between the first transverse conduit 220 and the second transverse conduit 222. An internal surface of the second transverse conduit 222 defines a second transverse flow passage 226 through the transverse portion 136. The internal surface of the first transverse conduit 220 may directly face the external surface of the second transverse conduit 222 along a direction normal to the transverse axis 176. The transverse member 230 may be a hollow tube or a solid rod, for example.

The first connection portion 182 of the nozzle portion 138 may include a first land 240 and a second land 242 disposed radially within the first land 240. The first transverse conduit 220 may be received within a recess defined by the first land 240, such that the first transverse conduit 220 overlaps with the first land 240 along the transverse axis 176. The second transverse conduit 222 may be received within a recess defined by the second land 242, such that the second transverse conduit 222 overlaps with the second land 242 along the transverse axis 176. It will be appreciated that each of the first land 240 and the second land 242 may at least partly define the first transverse flow passage 224 and the second transverse flow passage 226, respectively. The first land 240 may directly face the second land 242 along a direction normal to the transverse axis 176. According to an aspect of the disclosure, each of the first land 240 and the second land 242 has a circular cylindrical shape.

The first transverse conduit 220 may form a seal with the first land 240, and the second transverse conduit 222 may form a seal with the second land 242. According to an aspect of the disclosure, an external surface of the first transverse conduit 220 is welded or brazed to the first land 240, and an external surface of the second transverse conduit 222 is welded or brazed to the second land 242. However, it will be appreciated that other means of fastening and sealing known in the art may be applied between the first transverse conduit 220 and the first land 240, and between the second transverse conduit 222 and the second land 242.

The second transverse flow passage 226 may be fluidly coupled to the supply of exhaust fluid 124 via the exhaust fluid conduit 130, to selectively receive exhaust fluid from the supply of exhaust fluid 124. The first transverse flow passage 224 may be fluidly coupled to the supply of pressurized gas 126 via the gas conduit 132, to selectively receive pressurized gas from the supply of pressurized gas 126. In turn, the first transverse flow passage 224, the first transitional flow passage 256, and the first axial flow passage 204 may compose a pressurized gas flow path; and the second transverse flow passage 226, the second transitional flow passage 258, and the second axial flow passage 206 may compose an exhaust fluid flow path.

According to an aspect of the disclosure, the pressurized gas flow path is free from fluid communication with the exhaust fluid flow path upstream of the nozzle tip 158. Accordingly, there may be no fluid communication between the pressurized gas flow path and the exhaust fluid flow path at any point upstream of the nozzle tip 158. A downstream direction may extend along the pressurized gas flow path from the first transverse flow passage 224 toward the first axial flow passage 204 via the first transitional flow passage 256. Similarly, the downstream direction may extend along the exhaust fluid flow path from the second transverse flow passage 226 toward the second axial flow passage 206 via the second transitional flow passage 258. Conversely, an upstream direction may extend opposite to the downstream direction.

The second connection portion 184 may include a land 244, and the transverse member 230 may be received within a recess defined by the land 244, such that the transverse member 230 overlaps with the land 244 along the transverse axis 176. An external surface of the transverse member 230 may be welded or brazed to the land 244. According to an aspect of the disclosure, the land 244 has a circular cylindrical shape.

The nozzle portion 138 includes a transition section 250, which includes a first transition conduit 252 and a second transition conduit 254. The second transition conduit 254 may be disposed within the first transition conduit 252, such that an inner surface of the first transition conduit 252 and an outer surface of the second transition conduit 254 define a first transition flow passage 256 therebetween. Further, an inner surface of the second transition conduit 254 may define a second transition flow passage 258. The inner surface of the first transition conduit 252 may directly face the outer surface of the second transition conduit 254 along either the longitudinal axis 174 or the radial direction 160. According to an aspect of the disclosure, the first transition conduit 252 may be concentric with the second transition conduit 254, such that a centerline of the first transition conduit 252 may be coincident with a centerline of the second transition conduit 254.

Either of the first transition conduit 252 or the second transition conduit 254 may include a miter elbow or a smooth radius elbow. According to an aspect of the disclosure, a smooth radius elbow has a radius of curvature that is at least 15% of an internal diameter of the corresponding elbow flow passage, where the radius of curvature is measured along the corresponding flow passage centerline.

The first land 240 may be fixed to the first axial conduit 200 via the first transition conduit 252, and the second land 242 may be fixed to the second axial conduit 202 via the second transition conduit 254. In turn, the first transverse flow passage 224 may be fluidly coupled to the first axial flow passage 204 via the first transitional flow passage 256, and the second transverse flow passage 226 may be fluidly coupled to the second axial flow passage 206 via the second transitional flow passage 258. Further, the first transition conduit 252 may include a septum 260 that blocks fluid communication between the second connection portion 184 and the first transitional flow passage 256.

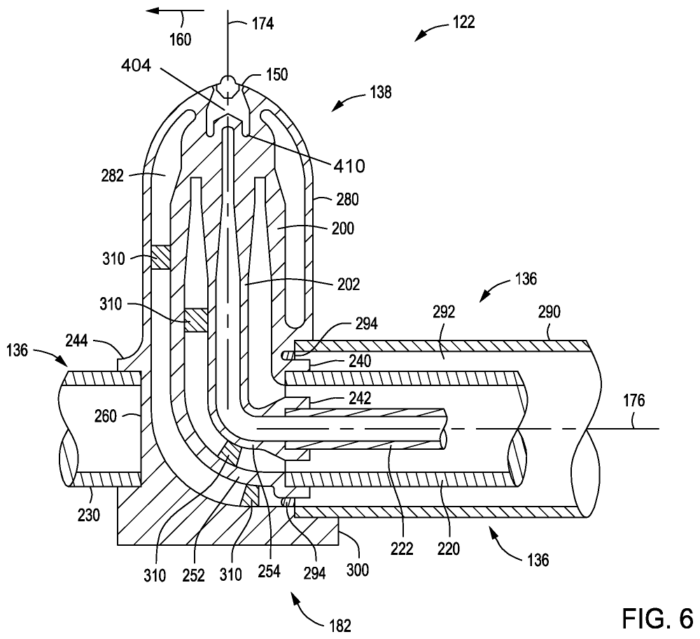

FIG. 6 is a cross-sectional view of an injector assembly 122 along section line 4-4, according to an aspect of the disclosure. The injector assembly 122 may include a shell 280 that at least partially surrounds the first axial conduit 200, the first transition conduit 252, or both. An internal surface of the shell 280 may directly face an external surface of the first axial conduit 200 along the radial direction 160.

A shell volume 282 may be at least partly defined between an interior surface of the shell 280 and an exterior surface of the first axial conduit 200. Further, the shell volume 282 may also be at least partly defined between an interior surface of the shell 280 and an exterior surface of the first transition conduit 252. According to an aspect of the disclosure, the shell volume 282 is exclusively defined between the interior surface of the shell 280 and both the exterior surface of the first axial conduit 200 and the exterior surface of the first transition conduit 252.

The injector assembly 122 may also include a third transverse conduit 290 disposed radially outside of the first transverse conduit 220, such that the first transverse conduit 220 is disposed within the third transverse conduit 290. As illustrated in FIG. 6, the exterior surface of the first transverse conduit 220 may directly face an interior surface of the third transverse conduit 290 along a direction normal to the transverse axis 176. Further, an exterior surface of the shell 280 may be in direct contact with exhaust gas when the injector assembly 122 is installed in the exhaust duct 120. Moreover, the exterior surface of the first axial conduit 200 may not be in direct contact with exhaust gas when the injector assembly 122 is installed in the exhaust duct 120 because the shell 280 may completely block fluid communication between the exhaust gas and the exterior surface of the first axial conduit 200.

The interior surface of the third transverse conduit 290 and the exterior surface of the first transverse conduit 220 may define a third transverse flow passage 292 therebetween. The third transverse flow passage 292 may be in direct fluid communication with the shell volume 282. Alternatively, the third transverse flow passage 292 may be blocked from fluid communication with the shell volume 282 by a seal 294. The seal 294 may be made from a metal, a ceramic, or any other material suitable for forming a seal in an exhaust environment.

The first connection portion 182 may further include a third land 300 disposed radially outside of the first land 240. The third transverse conduit 290 may be received within a recess defined by the third land 300, such that the third transverse conduit 290 overlaps with the third land 300 along the transverse axis 176. The third land 300 may directly face the first land 240 along a direction normal to the transverse axis 176.

The third transverse conduit 290 may form a seal with the third land 300. According to an aspect of the disclosure, an external surface of the third transverse conduit 290 is welded or brazed to the third land 300. However, it will be appreciated that other means of fastening and sealing may be applied between the third transverse conduit 290 and the third land 300.

The nozzle portion 138 may include one or more struts 310 disposed in the exhaust fluid flow path, the compressed gas flow path, the shell volume 282, or combinations thereof. For example, a strut 310 may extend from an interior surface of the shell 280 to an exterior surface of either the first transition conduit 252 or the first axial conduit 200, and be rigidly fixed to the shell 280 at least one of the first transition conduit 252 and the first axial conduit 200. Further, a strut 310 may extend from an interior surface of either the first transition conduit 252 or the first axial conduit 200 to an exterior surface of either the second transition conduit 254 or the second axial conduit 202; and the strut 310 may be rigidly fixed to either the first transition conduit 252 or the first axial conduit 200, and rigidly fixed to either the second transition conduit 254 or the second axial conduit 202. The struts 310 may promote structural strength of the nozzle portion 138, provide flow conditioning function for fluid flows within the nozzle portion 138, or both.

Any of the struts 310 may be impermeable to fluid flow or permeable to fluid flow, and the nozzle portion 138 can include a plurality of struts 310 that exhibit a mix of permeability and impermeability to fluid flow. A strut 310 that is impermeable to fluid flow may be formed from a solid material, such as a solid metal, for example. A strut 310 that is permeable to flow may be formed from a lattice structure, such as a metallic lattice structure, for example.

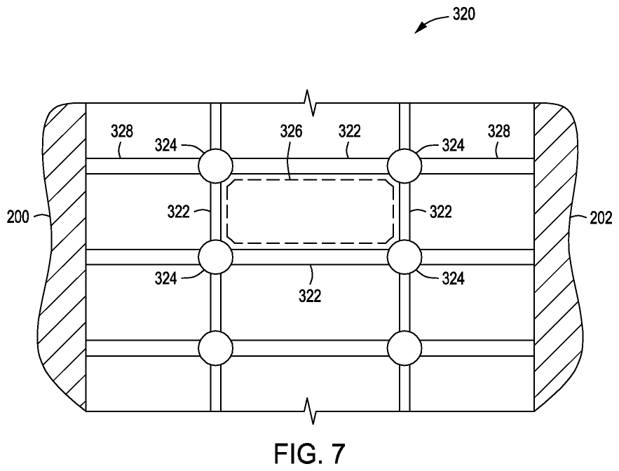

FIG. 7 is a schematic view of a lattice structure 320, according to an aspect of the disclosure. The lattice structure 320 may include a plurality of beams 322 that are rigidly interconnected with one another via a plurality of nodes 324. The plurality of beams 322 and the plurality of nodes 324 may define a plurality of cells 326 that are permeable to fluid flow. The plurality of beams 322 includes a plurality of edge beams 328 that are rigidly fixed to a node 324 on one end, and rigidly fixed to a flowpath-defining surface of the nozzle portion 138 on the other end. As illustrated in FIG. 7, the lattice structure 320 spans the first axial flow passage 204 between the first axial conduit 200 and the second axial conduit 202. However, it will be appreciated that the lattice structure 320 may be applied between other internal surfaces of the nozzle portion 138, and may compose at least a portion, or an entirety, of any of the struts 310 illustrated in FIG. 6.

The lattice structure 320 may be a two-dimensional lattice structure, where all nodes of the plurality of nodes 324 lie in a single plane. Alternatively, the lattice structure 320 may be a three-dimensional lattice structure, where the plurality of nodes 324 lies in multiple, non-coplanar planes. Although the lattice structure 320 is schematically represented as a rectangular lattice structure in FIG. 7, it will be appreciated that the lattice structure 320 may embody any known lattice structure design.

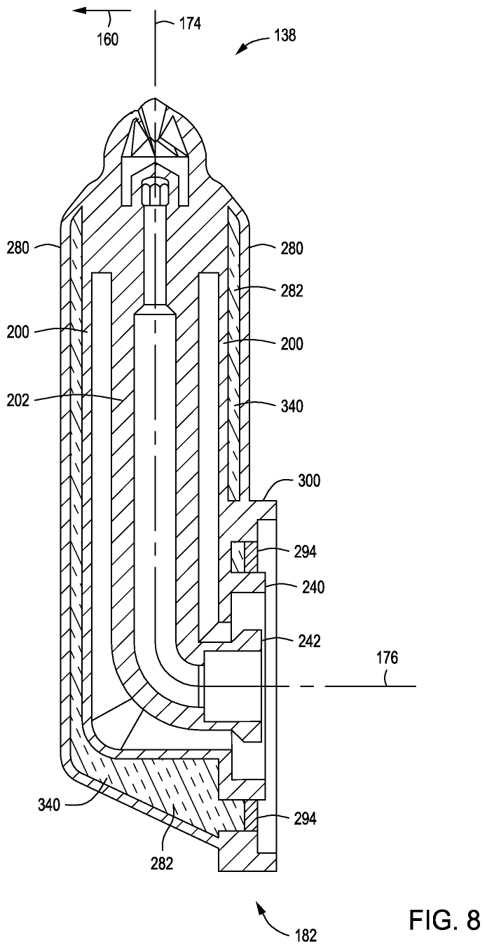

FIG. 8 is a cross-sectional view of a nozzle portion 138 along section line 4-4, according to an aspect of the disclosure. As illustrated in FIG. 8, the shell volume 282 may be filled with insulation 340. The insulation 340 may be a gas-phase insulation, such as air; a solid-phase pourable insulation that is poured into the shell volume 282 via apertures through the first connection portion 182; or any other suitable insulation known in the art. Further, the seal 294 may be installed after pouring the insulation 340 into the shell volume 282 to retain the insulation 340 within the shell volume 282, as well as to effect a fluid seal of the shell volume 282. The insulation 340 may benefit the life and/or operability of the nozzle portion 138 by limiting heat transfer from the exhaust gas 108 into the first axial flow passage 204, the second axial flow passage 206, or both.

The insulation 340 may include mineral insulation such as perlite, vermiculite, silica, or any other mineral insulation material known in the art. The insulation 340 may be a pourable, solid-phase insulation containing between 60-90% amorphous silica, 5-40% silicon carbide, and 0-5% aluminum oxide.

According to an aspect of the disclosure, the insulation 340 has a thermal conductivity that is less than 10 W/m·K. According to another aspect of the disclosure, the insulation 340 has a thermal conductivity that is less than 2 W/m·K. The insulation 340 may have a thermal conductivity that is less than a thermal conductivity of the shell 280. According to yet another aspect of the disclosure, the insulation 340 may be Free Flow 1000x, as manufactured by Promat Incorporated.

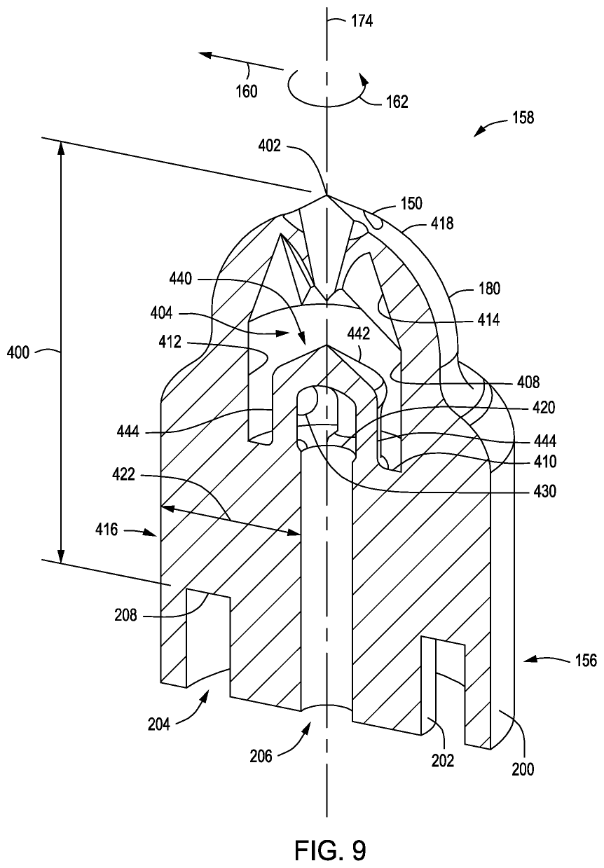

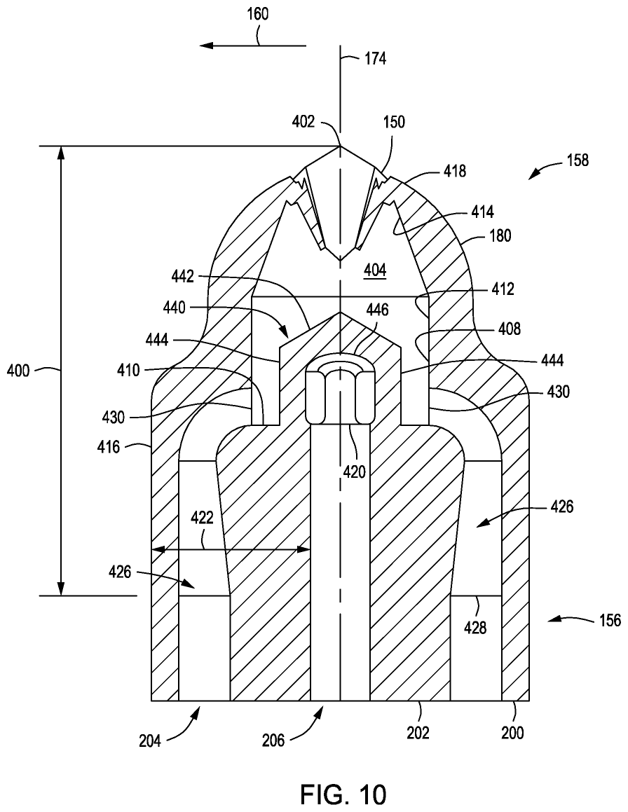

FIG. 9 is a perspective cross-sectional view of a nozzle tip 158 and a nozzle extension 156, according to an aspect of the disclosure; and FIG. 10 is a front cross-sectional view of a nozzle tip 158 and a nozzle extension 156, according to an aspect of the disclosure. The cross sections for each of FIG. 9 and FIG. 10 are along a cutting planes that include the longitudinal axis 174.

The nozzle tip 158 may have an overall longitudinal length 400 that extends along the longitudinal axis 174 from the end 208 of the first axial flow passage 204 to a distal end 402 of the nozzle tip 158. The nozzle extension 156 may extend from the end 208 of the first axial flow passage 204 and away from the nozzle tip 158 along the longitudinal axis 174. Thus, the nozzle tip 158 may directly abut the nozzle extension 156 at the location of the end 208 of the first axial flow passage 204, along the longitudinal axis 174. The second axial flow passage 206 may extend through both the nozzle extension 156 and the nozzle tip 158.

An internal surface 408 of the nozzle tip 158 defines a chamber 404 therein. The internal surface 408 may include a floor surface 410, a sidewall surface 412, and a ceiling surface 414, which at least partly define the chamber 404. An intersection of the second axial flow passage 206 with the floor surface 410 defines an axial aperture 420 through the floor surface 410. The floor surface 410 may extend along the radial direction 160 from the axial aperture 420 to the sidewall surface 412. The sidewall surface 412 may extend along the longitudinal axis 174 from the floor surface 410 to the ceiling surface 414; and the ceiling surface may taper away from the sidewall surface 412 along both the longitudinal axis 174 and the radial direction 160 toward the distal end 402.

According to an aspect of the disclosure, the floor surface 410 is a planar surface that extends perpendicular to the longitudinal axis 174. According to another aspect of the disclosure, the sidewall surface 412 is a cylindrical surface that extends along and centered about the longitudinal axis 174. The second axial flow passage 206 may be a cylindrical flow passage that is centered on the longitudinal axis 174.

The nozzle tip 158 may include a side wall 416 having a radial thickness 422 that extends from the external surface of the first axial conduit 200 to an internal surface of the second axial flow passage 206 along the radial direction 160. The radial thickness 422 may be located between the end 208 of the first axial flow passage 204 and the ceiling surface 414 along the longitudinal axis 174. At the circumferential location illustrated in FIG. 9, the nozzle tip 158 is solid and continuous along the radial thickness 422, and is therefore free from chambers, voids, or flow passages along the radial thickness 422, at that particular location about the circumferential direction 162.

At another circumferential location, as illustrated in FIG. 10, the radial thickness 422 of the nozzle tip 158 may define a plurality of turning flow passages 426 therethrough. Accordingly, each turning flow passage 426 may be located between the external surface of the first axial conduit 200 and the second axial flow passage 206, along the radial direction 160. An inlet aperture 428 of each turning flow passage 426 may be in direct fluid communication with the first axial flow passage 204. An intersection of each turning flow passage 426 with the sidewall surface 412 may define a plurality of radial apertures 430 through the sidewall surface 412.

Thus, the first axial flow passage 204 may be in fluid communication with the chamber 404 via the plurality of turning flow passages 426. Further, each turning flow passage 426 may be discrete and arranged fluidly in parallel with all other turning flow passages 426, such that the only fluid communication between the turning flow passages is via the first axial flow passage 204 or the chamber 404. In other words, the turning flow passages 426 may be free from fluid communication with one another between the respective inlet apertures 428 and outlet apertures 430.

Each of the radial apertures 430 may directly face the longitudinal axis 174 along the radial direction 160. Thus, the turning flow passages 426 may turn a flow therethrough from a longitudinal direction at the respective inlet aperture 428 to a radial direction at the respective outlet aperture 430. In turn, each radial aperture 430 may be perpendicular to the axial aperture 420. Alternatively, each turning flow passage 426 may turn a flow therethrough at least partly toward the longitudinal axis 174 along the radial direction 160.

According to an aspect of the disclosure, the radial thickness 422 may define two or more turning flow passages 426. According to another aspect of the disclosure, the radial thickness 422 may define four or more turning flow passages 426.

The nozzle tip 158 may further include an impingement portion 440 including a roof 442 and one or more columns 444. The roof 442 may be rigidly fixed to the floor surface 410 via the one or more columns 444. An inner surface 446 of the roof may directly face the axial aperture 420 along the longitudinal axis 174. The impingement portion 440 may include two or more columns 444, and spaces between the two or more columns 444 may define impingement apertures that are aligned with the plurality of radial apertures 430, such that each radial aperture 430 directly faces the longitudinal axis 174.

The nozzle tip 158 may further include an end wall 418 that defines the plurality of outlet apertures 150 therethrough, where the plurality of outlet apertures 150 are in direct fluid communication with the chamber 404. The end wall 418 may abut the side wall 416 at or near an elevation where the sidewall surface 412 meets the ceiling surface 414 along the longitudinal axis 174.

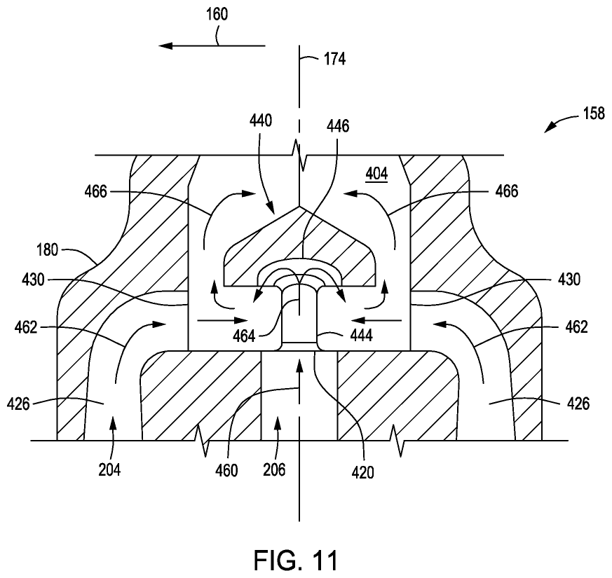

FIG. 11 is a front cross-sectional view illustrating flow patterns within a nozzle tip 158, according to an aspect of the disclosure. A flow of exhaust fluid 460 may enter the chamber 404 via the second axial flow passage 206 and the axial aperture 420. The flow of exhaust fluid 460 may have a bulk velocity that is coaxial with the longitudinal axis 174.

A flow of pressurized gas 462 may enter the chamber 404 via the plurality of turning flow passages 426 and the plurality of radial apertures 430. According to an aspect of the disclosure, a radial velocity component of the flow of pressurized gas 462 along the radial direction 160 is greater than an axial velocity component of the flow of pressurized gas 462 along the longitudinal axis 174. According to another aspect of the disclosure, an angle between the flow of exhaust fluid 460 and the flow of pressurized gas 462 may lie between 80 degrees and 100 degrees. Thus, the flow of pressurized gas 462 may enter the chamber 404 in a substantially perpendicular cross-flow relationship with the flow of exhaust fluid 460.

A first mixture 464 of the exhaust fluid and the pressurized gas may impinge the inner surface 446 of the impingement portion 440, and the turn at least 90 degrees away from the longitudinal axis 174 along the radial direction. Further mixing between the exhaust fluid and the pressurized gas may then result in a second mixture 466 downstream in the chamber 404 before exiting the nozzle tip 158 via the plurality of outlet apertures 150.

The cross-flow relationship between the flow of exhaust fluid 460 and the flow of pressurized gas 462 may generate shear and turbulence that promote atomization and mixing of the exhaust fluid with the pressurized gas. Further, impingement of the first mixture 464 on the impingement portion 440 may introduce additional shear and turbulence that further promote atomization and mixing of the exhaust fluid with the pressurized gas before leaving the nozzle tip 158 via the plurality of outlet apertures 150.

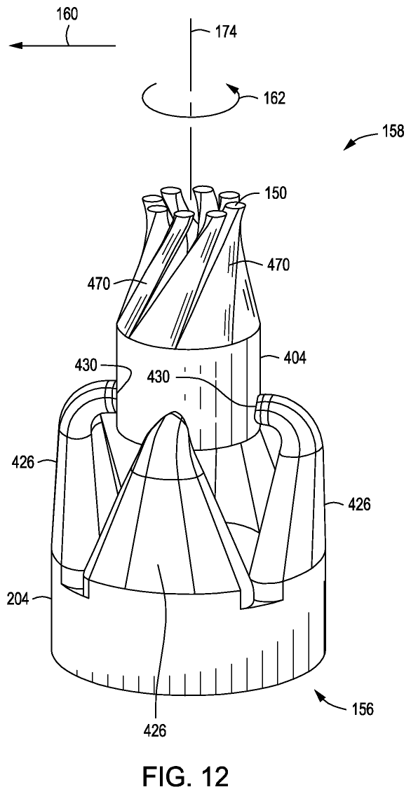

FIG. 12 is an inverse flow surface view of a nozzle tip 158, according to an aspect of the disclosure. To aid in describing flow passages within the nozzle tip 158, FIG. 12 illustrates surfaces within the nozzle tip 158 that are defined by direct contact with fluid flowing through the nozzle tip 158, should the fluid be hypothetically frozen solid and the structure of the nozzle tip 158 defining the flow passages should be hypothetically removed. Although FIG. 12 represents a hypothetical removal of the nozzle tip 158 structure that defines the internal flow passages, element labels for the corresponding affirmative structure are used in FIG. 12 for clarity and consistency.

The end wall 418 may define a plurality of outlet flow passages 470 that extend from ceiling apertures through the ceiling surface 414 to corresponding outlet apertures 150. Each of the outlet flow passages 470 may be discrete and arranged fluidly in parallel with all other outlet flow passages 470, such that the only fluid communication between the outlet flow passages 470 is via the chamber 404 or via outside the nozzle tip 158. In other words, the outlet flow passages 470 may be free from fluid communication with one another between respective ceiling apertures and outlet apertures 150.

Each outlet flow passage 470 may slope along the circumferential direction 162 and/or slope toward the longitudinal axis 174 along the radial direction 160, as each outlet flow passage extends from its corresponding ceiling aperture to its corresponding outlet aperture 150. According to an aspect of the disclosure, each outlet flow passage 470 monotonically slopes along the circumferential direction 162 as each outlet flow passage 470 extends from its corresponding ceiling aperture to its corresponding outlet aperture 150. According to another aspect of the disclosure, each outlet flow passage 470 monotonically slopes along the radial direction 160 toward the longitudinal axis 174, as each outlet flow passage 470 extends from its corresponding ceiling aperture to its corresponding outlet aperture 150. According to yet another aspect of the disclosure, each outlet flow passage 470 twists along a helical path that tapers down along the radial direction 160, as each outlet flow passage 470 extends from its corresponding ceiling aperture to its corresponding outlet aperture 150. As a result, the shape of the outlet flow passages 470 may advantageously impart streamwise vorticity or swirl into the flow exiting the outlet apertures 150. According to another aspect of the disclosure, the outlet flow passages 470 may not impart swirl or streamwise vorticity into the flow exiting the outlet apertures 150.

The outlet flow passages 470 may be uniformly distributed around the longitudinal axis 174, each being uniformly spaced from adjacent outlet flow passages 470 along the circumferential direction 162. Further, the outlet flow passages 470 may all be uniformly spaced from the longitudinal axis 174 along the radial direction 160.

A flow area of each outlet aperture 150 may be less than a flow area of each corresponding ceiling aperture. According to an aspect of the disclosure, a flow area of each outlet flow passage 470 tapers down from each ceiling aperture to a corresponding outlet aperture 150, as each outlet flow passage extends from its corresponding ceiling aperture to its corresponding outlet aperture 150. According to another aspect of the disclosure, a flow area of each outlet flow passage 470 monotonically decreases from each ceiling aperture to a corresponding outlet aperture 150, as each outlet flow passage 470 extends from its corresponding ceiling aperture to its corresponding outlet aperture 150.

### INDUSTRIAL APPLICABILITY

Aspects of the present disclosure provide exhaust injection systems and exhaust fluid injectors with improved performance and reliability compared to conventional approaches, and do so with structures that are less expensive to manufacture.

According to an aspect of the disclosure, an entirety of the nozzle portion 138 is manufactured by three-dimensional (3D) printing or additive manufacturing to yield a single unitary or monolithic structure that is free from the seams or joints that result from assembly of conventional injectors or nozzles from a plurality of separately manufactured parts. The nozzle portion 138 may be fabricated by the 3D printing processes of fused filament fabrication, powder bed fusion (PBF), or any other 3D printing process known in the art. PDF processes may include direct metal laser sintering, selective laser sintering, selective laser melting, multi jet fusion, or electron beam melting, for example. The nozzle portion 138 may be 3D printed from metals such as steel alloys, stainless steel, nickel, nickel alloys, titanium, or any other metallic material known in the art of 3D printing.

The unitary or monolithic structure resulting from 3D printing of the nozzle portion 138 enables advantageous internal mixing flow paths that would be impractical or impossible to manufacture by conventional machining or casting manufacturing processes. For example, forming the plurality of distinct turning flow passages 426 in the thickness of the side wall 416 enhances the atomization and mixing effectiveness of the pressurized gas flow 462 on the exhaust fluid flow 460 within the chamber 404, by tailoring the flow cross sections and the path of the turning flow passages 426, and focusing the momentum of the pressurized gas flow 462 into discrete jets in cross-flow arrangement with the exhaust fluid flow 460 inside the chamber 404. Further, 3D printing of the outlet flow passages 470 within the end wall 418 enables advantageous tailoring of the flow cross sections and path of the outlet flow passages 470 to promote atomization and mixing of the exhaust fluid 152 with the exhaust gas 108 within an exhaust duct 120. As a result, improved spatial and temporal mixing uniformity of the exhaust fluid 152 with the exhaust gas 108 improve conversion performance of downstream emissions aftertreatment devices 106. For example, improved spatial and temporal mixing uniformity of a reductant within the exhaust gas 108 may advantageously promote NOx conversion in a downstream SCR catalyst.

The unitary or monolithic structure resulting from 3D printing of the nozzle portion 138 promotes reliability of the injector assembly 122 by eliminating seams, joints, and/or seals that are present in conventional multi-component nozzle assemblies. For example, elimination of seams, joints, and/or seals may promote reliability by reducing potential leak paths through the nozzle portion 138.

Further, 3D printing of the nozzle portion 138 promotes reliability by enabling integration of structural reinforcement, such as the struts 310, which may beneficially extend the life of the nozzle portion by improving resistance to thermal stress and other mechanical stresses within the nozzle portion 138. In particular aspects, the struts 310 may include a fluid-permeable lattice structure 320 that is integrally printed within internal flowpaths of the nozzle portion 138 to simultaneously promote structural strength and fluid mechanical performance. In addition, the struts 310 may be rigidly fixed to internal surfaces of flow passages within the nozzle portion 138 by integrally forming the struts 310 with the nozzle portion 138 via 3D printing.

3D printing of the nozzle portion 138 may also permit extension of the shell volume 282, the insulation 340, or both, in close proximity to the distal end 402 and outlet apertures 150, thereby providing the benefits of thermal insulation close to the distal end 402. For example, as illustrated in FIG. 6, the shell volume 282 may overlap with the chamber 404 along the longitudinal direction 174, thereby locating at least a part of the shell volume 282 in close proximity to the distal end 402. Similarly, the shell volume 282 may extend beyond the floor surface 410 of the chamber 404 along the longitudinal direction 174, such that a least a portion of the shell volume 282 may be located between the floor surface 410 and the distal end 402. In turn, the insulation 340 disposed within the shell volume 282 may also overlap with the chamber 404 along the longitudinal direction 174, or extend beyond the floor surface 410 along the longitudinal direction 174, because the insulation 340 may be coextensive with any portion of the shell volume 282.

Moreover, 3D printing of the nozzle portion 138 reduces the cost of manufacturing such high-performing injector assemblies 122 by eliminating manufacturing steps associated with multi-component nozzle portions, which may include conventional casting steps, conventional machining steps, and assembly of the multiple components to form the nozzle portion 138.

It will be appreciated that the present disclosure contemplates all possible permutations of features disclosed herein, even if all features of a particular permutation are not shown together in a single drawing, for the purpose of promoting clarity of individual features in the several drawings.

Further, it will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

1. An injector for a diesel exhaust fluid (DEF) delivery system, the injector comprising:
a first conduit extending around a longitudinal axis and extending along a longitudinal direction, the longitudinal direction being parallel to the longitudinal axis;
a second conduit extending along the longitudinal direction and disposed within the first conduit;
a nozzle tip having a side wall and an end wall,
the side wall having a thickness extending along a radial direction from an external surface of the nozzle tip to an inner surface of the second conduit, the radial direction being perpendicular to the longitudinal direction,
the end wall defining an outlet flow passage therethrough, the outlet flow passage being in fluid communication with the first conduit and the second conduit via a chamber defined by an internal surface of the nozzle tip; and
a shell surrounding the first conduit and being spaced apart from the first conduit along the radial direction,
wherein the side wall defines a plurality of inlet flow passages within the thickness of the side wall,
an internal surface of the side wall defines a plurality of inlet apertures therethrough, each inlet flow passage of the plurality of inlet flow passages terminating at a corresponding inlet aperture of the plurality of inlet apertures, each inlet aperture of the plurality of inlet apertures facing the longitudinal axis along the radial direction via the chamber,
each inlet flow passage of the plurality of inlet flow passages extends from an end of the first conduit to a corresponding inlet aperture of the plurality of inlet apertures, and
the plurality of inlet flow passages is in direct fluid communication with the chamber via the plurality of inlet apertures.

2. The injector of claim 1, wherein the shell is rigidly fixed to the nozzle tip.

3. The injector of claim 1, further comprising solid-phase insulation disposed between the shell and the first conduit, a thermal conductivity of the solid-phase insulation being less than a thermal conductivity of the first conduit.

4. The injector of claim 1, wherein an internal surface of the shell is not in fluid communication with an internal surface of the second conduit.

5. The injector of claim 4, wherein the internal surface of the shell is not in fluid communication with an internal surface of the first conduit.

6. The injector of claim 1, further comprising a strut extending from an internal surface of the shell to an external surface of the first conduit, the strut being rigidly fixed to both the internal surface of the shell and the external surface of the first conduit, the strut having a lattice structure that is permeable to fluids.

7. The injector of claim 1, further comprising:
a third conduit extending along a transverse direction, the third conduit being in direct fluid communication with the first conduit via a first transition conduit, the transverse direction being transverse to the longitudinal direction; and
a fourth conduit extending along the second direction and disposed within the third conduit, the fourth conduit being in direct fluid communication with the second conduit via a second transition conduit.

8. The injector of claim 7, wherein the second transition conduit is a smooth radius elbow.

9. The injector of claim 8, wherein the first transition conduit is a smooth radius elbow that is concentric with the second transition conduit.

10. The injector of claim 1, further comprising a strut extending from an internal surface of the first conduit to an external surface of the second conduit, the strut being rigidly fixed to both the internal surface of the first conduit and the external surface of the second conduit.

11. The injector of claim 7, wherein the only fluid communication between an internal surface of the third conduit and an internal surface of the fourth conduit is via the chamber within the nozzle tip.

12. The injector of claim 1, wherein the first conduit, the second conduit, and the shell are all integrally formed from a same material.

13. (canceled)

14. An exhaust system for an internal combustion engine, the exhaust system comprising:
an exhaust conduit that receives exhaust gas from the internal combustion engine; and
an injector for injecting diesel exhaust fluid (DEF) into the exhaust conduit, the injector comprising
a first conduit extending around a longitudinal axis and extending along a longitudinal direction, the longitudinal direction being parallel to the longitudinal axis;
a second conduit extending along the longitudinal direction and disposed within the first conduit;
a nozzle tip having a side wall and an end wall,
the side wall having a thickness extending along a radial direction from an external surface of the nozzle tip to an inner surface of the second conduit, the radial direction being perpendicular to the longitudinal direction,
the end wall defining an outlet flow passage therethrough, the outlet flow passage being in fluid communication with the first conduit and the second conduit via a chamber defined by an internal surface of the nozzle tip, the chamber being in fluid communication with the exhaust conduit via the outlet flow passage; and
a shell surrounding the first conduit and being spaced apart from the first conduit along the radial direction,
wherein the side wall defines a plurality of inlet flow passages within the thickness of the side wall,
an internal surface of the side wall defines a plurality of inlet apertures therethrough, each inlet flow passage of the plurality of inlet flow passages terminating at a corresponding inlet aperture of the plurality of inlet apertures, each inlet aperture of the plurality of inlet apertures facing the longitudinal axis along the radial direction via the chamber,
each inlet flow passage of the plurality of inlet flow passages extends from an end of the first conduit to a corresponding inlet aperture of the plurality of inlet apertures, and
the plurality of inlet flow passages is in direct fluid communication with the chamber via the plurality of inlet apertures.

15. The exhaust system of claim 14, wherein the end wall of the nozzle tip is disposed within the exhaust conduit.

16. The exhaust system of claim 14, wherein the first conduit is fluidly coupled to a supply of pressurized air, and the second conduit is fluidly coupled to a supply of DEF.

17. The exhaust system of claim 16, further comprising solid-phase insulation disposed between the shell and the first conduit, a thermal conductivity of the solid-phase insulation being less than a thermal conductivity of the first conduit.

18. The injector of claim 1, further comprising a first strut extending from an internal surface of the shell to an external surface of the first conduit, the first strut being rigidly fixed to both the internal surface of the shell and the external surface of the first conduit.

19. The injector of claim 18, further comprising a second strut extending from an internal surface of the shell to an external surface of the first conduit, the second strut being rigidly fixed to both the internal surface of the shell and the external surface of the first conduit, the second strut having a lattice structure that is permeable to fluids.

20. (canceled)

21. The injector of claim 1, wherein the second conduit terminates at an outlet aperture of the second conduit, and an internal surface of the second conduit is in fluid communication with the chamber via the outlet aperture of the second conduit, and
each inlet aperture of the plurality of inlet apertures is disposed between the outlet aperture of the second conduit and the end wall along the longitudinal direction.

22. The injector of claim 14, wherein the second conduit terminates at an outlet aperture of the second conduit, and an internal surface of the second conduit is in fluid communication with the chamber via the outlet aperture of the second conduit, and
each inlet aperture of the plurality of inlet apertures is disposed between the outlet aperture of the second conduit and the end wall along the longitudinal direction.
